(19) United States
(12) Patent Application Publication
(10) Pub. No.: US 2024/0151215 A1
(43) Pub. Date: May 9, 2024

(54) DEVICES AND METHODS FOR CONVERTING THERMAL, MECHANICAL AND/OR ELECTRICAL ENERGY QUANTITIES

(71) Applicant: Thilo Ittner, Wangen im Allgäu (DE)

(72) Inventor: Thilo Ittner, Wangen im Allgäu (DE)

(21) Appl. No.: 18/506,649

(22) Filed: Nov. 10, 2023

Related U.S. Application Data
(63) Continuation-in-part of application No. 18/196,275, filed on May 11, 2023.

(30) Foreign Application Priority Data
May 13, 2022 (DE) 102022112016.3
Jun. 8, 2022 (DE) 102022114439.9

(51) Int. Cl. F03G 7/06

(52) U.S. Cl. CPC F03G 7/0641; F03G 7/06112

(57) ABSTRACT

A device for converting thermal, mechanical and/or electrical energy quantities into other such energy quantities comprises at least one volume (97, 98, 127, 128, 129) comprising a liquid quantity (31, 32, 130, 131, 132, 202) and at least one partial volume (33, 34, 133, 134, 135) with a working medium. The partial volume is bounded by volume delimiting elements and a liquid surface. At least one of the volume delimiting elements or the liquid quantity can change its position relative to other volume delimiting elements or the liquid quantity in such a way as to change the size of the partial volume. The partial volume and the liquid quantity perform a rotational movement so that centrifugal forces act on the liquid quantity. Heat quantities are suppliable to or removable from at least one liquid quantity in that a part of the liquid quantity can flow into and out of the volume from outside the device through openings (49, 50, 52, 149) or in that the at least one liquid quantity is thermally coupled to another liquid quantity by heat exchangers.

A thermoelectric, thermomechanical or thermal converter with at least one of the devices is provided, with which a Stirling, Ericsson, Vuilleumier, Clausius-Rankine, Joule process or a mixed form of the processes is realized.

### RELATED APPLICATIONS

This application is a continuation-in-part of U.S. application Ser. No. 18/196,275, filed May 11, 2023, which claims the benefit under 35 U.S.C. § 119(a) of German Patent Application No. 102022112016.3, filed May 13, 2022, and of German Patent Application No. 102022114439.9, filed Jun. 8, 2022, each of which is incorporated by reference herein.

### TECHNICAL FIELD

The invention relates to a device for converting thermal, mechanical and/or electrical energy quantities, a thermoelectric, thermomechanical or thermal converter and a computer-controlled or electronically controlled method for operating the thermoelectric, thermomechanical or thermal converter according to the independent claims.

### BACKGROUND

For the efficient conversion of mechanical or electrical energy into heat quantities, heat pumps that use thermodynamic cycle processes are primarily used today, but also other methods that use adsorption or absorption processes, for example. Similarly, heat engines that use thermodynamic cyclic processes are primarily used for the efficient conversion of heat quantities into mechanical/electrical energy. Thermodynamic cyclic processes include those that involve a phase transition of a working medium, e.g. the Clausius-Rankine process. Processes without a phase transition of the gaseous working medium are, for example, the Ericsson process or the Stirling process. Methods without phase transition have amongst others the advantage that they are suitable for the use of heat sources and heat sinks with particularly high temperature differences, as they typically have a lower drop in efficiency at high temperature differences compared to lower temperature differences than is the case with methods with phase transition. They are also suitable for generating heat/cold quantities that have a particularly high temperature difference compared to a cold/heat sink. Methods without phase transition also include the Vuilleumier process and the duplex Stirling process, which are used to convert heat quantities with certain temperatures into heat quantities with certain other temperatures, whereby the duplex Stirling process consists of two Stirling processes that are coupled together and of which one is used in the left-hand direction and the other in the right-hand direction, i.e. one as a heat pump and the other as a heat engine.

The efficiency of a thermodynamic cycle process can be described as the product of the degree of quality of the process and the theoretical maximum achievable Carnot efficiency. The Stirling and Vuilleumier processes can theoretically achieve very high efficiencies, which are theoretically higher than with other processes, especially at high temperature differences between useful/drive heat and the corresponding heat/cold sink, as the degree of quality of Stirling and Vuilleumier machines drops less sharply at higher temperature differences (compared to lower temperature differences) than is the case with other processes. They are therefore particularly suitable for high-temperature heat pumps or for heat engines that have heat sources with particularly high temperatures or particularly high temperature differences compared to the heat sinks.

However, conventional Stirling and Vuilleumier machines can have some disadvantages that can lead to the real achievable efficiency being significantly lower than the Carnot efficiency, i.e., the degree of quality is significantly lower than 1. These disadvantages can be particularly the following:

The expansion and/or compression of the working medium used in the working space is largely adiabatic and not isothermal. So-called “adiabatic losses” can therefore occur.

The heat exchanger surfaces are too small or the coupling of the supplied/dissipated heat quantities to the working medium is not sufficient to ensure a heat transfer that heats/cools the working medium sufficiently in the time available. So-called “heat exchanger losses” can therefore occur.

Dead spaces exist in Stirling and Vuilleumier machines. These are additional volumes apart from the compression and expansion spaces that contain working medium and are connected to the compression and expansion spaces in a gas-permeable manner. As a result, the working gas is not completely contained in the designated expansion or compression spaces during expansion or compression. Additionally, the working gas may even be in the compression volume during expansion and in the expansion volume during compression. In both cases, so-called “dead space losses” occur.

In the case of sealing elements or gaps, a part of the working medium can unintentionally escape from areas of higher pressures into areas of lower pressures, so that unintentional pressure losses or pressure changes occur in the working space as well as the flow of the working medium through the gaps or imperfectly sealing elements can cause flow losses. In applications such as in the patent application in Germany No. 10 2022 112 016.3, the flow of liquid through gaps can also cause unintentional flow losses and thermal losses, although these should be limited to a technically feasible minimum.

In rotary piston machines, e.g. in machines based on the trochoidal principle as in the device disclosed in DE2015949A1 or in principles similar to the Wankel motor, furthermore, so-called “shift losses” can occur. These are efficiency losses that can occur due to the fact that a part of the surface of the rotary piston is alternately in contact with a hot working medium and a cold working medium and thereby heat quantities can be transported between the two working media, which should not happen according to the ideal Stirling or Vuilleumier process and therefore can reduce the efficiency.

A large number of concepts are already known to minimize these efficiency losses, see the following examples:

Adiabatic losses are reduced, for example, by the heat exchangers being in direct contact with the working medium in the expansion and compression spaces (together referred to as “working spaces”)—in contrast to the widely used embodiment with heat exchangers through which the working medium flows when flowing from the expansion space into the compression space and vice versa (see, for example, the heat exchangers 7, 9 arranged outside the working spaces 3, 4 in FIG. 1 or DE2015949A1). This is the case, for example, in DE3015815C2 or in EP2657497B1.

Heat exchanger losses can be reduced by designing the surfaces of the heat exchangers that are in contact with the working medium as large as possible. This is the case in EP2657497B1, for example, in that metal plates, which are arranged very close to one another in large numbers, are periodically immersed in and removed from a liquid which supplies or removes heat.

Dead space losses can be significantly reduced by arranging the heat exchangers inside the working spaces, as for avoiding adiabatic losses, and thus additional volumes can be avoided in which a part of the working medium is constantly present, as is the case with heat exchangers arranged outside the working spaces (see, for example, FIG. 1). In addition, a non-sinusoidal, i.e. anharmonic or discontinuous piston movement can be used to ensure that the working medium is largely completely contained in the working space (compression space or expansion space) provided for this purpose during its compression or expansion. This is described in WO2010/139443A1 and, for example, in embodiments in this patent application.

There are already solutions for preventing flow losses in Stirling engines, such as, for example, roller sock seals or piston sealing rings, but these can have other disadvantages such as, for example, mechanical friction. In patent application DE 10 2022 114 439.9, volume delimiting elements are proposed which are intended to largely prevent the flow of liquid between different volumes, but here too, technical difficulties remain in sealing gaps as completely as possible, and additionally mechanical friction losses occur here when volume delimiting elements move relative to each other. There is also no guarantee that volumes connected by smallest gaps will continue to contain largely the same pressure, so that flows would be avoided in this way.

The avoidance of shift losses can be very specifically related to the embodiment. They occur, for example, in rotary piston machines and, in addition to sealing difficulties, are a major reason why they have not yet been able to establish themselves in practice.

### BRIEF DESCRIPTION OF THE FIGURES

The accompanying figures illustrate aspects and/or embodiments of the present disclosure by way of example for better understanding and for illustration purposes, where:

The attached figures represent exemplary aspects and/or embodiments of the invention for better understanding and illustration. It shows:

FIG. 1 a longitudinal section of a Stirling engine in gamma design according to the state of the art,

FIG. 2 the movement of the reciprocating pistons and the working space volume over time of the machine from FIG. 1 according to the state of the art,

FIG. 3 a 3D view of an embodiment of the device as a Stirling machine,

FIG. 4 a longitudinal section of this embodiment,

FIG. 5 a cross-section of this embodiment along the axis A-A,

FIG. 6 a 3D view of the volume change element of this embodiment with a part of the housing surrounding it,

FIG. 7 an anharmonic form of movement of a volume change element and a harmonic form of movement of a pressure change element as well as the resulting change in total volume over time,

FIG. 8a the shape of the recess in the volume change element of the embodiment in FIG. 3-6, in which an actuating element moves back and forth linearly,

FIG. 8b the shape of an alternative depression in the volume change element, which results in an anharmonic movement of the volume change element,

FIG. 9 a cross-section of another embodiment,

FIG. 10 a longitudinal section along the axis A-A through the part of this embodiment comprising the volume change element,

FIG. 11 a 3D view of the volume change element of this embodiment and one of three sliders,

FIG. 12a and FIG. 12b a 3D exploded view of a drive unit of the volume change element of this embodiment from different viewing directions,

FIG. 13 a possible form of movement of the volume change element of this embodiment relative to the housing,

FIG. 14a and FIG. 14b an alternative embodiment of a pressure change element in different phases of the movement,

FIG. 15 a sectional view along the axis A-A from FIG. 14a,

FIG. 16 a 3D view of the pressure change element of this embodiment of a pressure change element, and

FIG. 17 an alternative pressure change element in the form of an oscillating water ring.

### DETAILED DESCRIPTION

The task of embodiments of the invention is to provide a device for converting thermal, mechanical and/or electrical energy quantities, a thermoelectric, thermomechanical or thermal converter and a computer-controlled or electronically controlled method for operating the thermoelectric, thermomechanical or thermal converter that enable a largely isothermal compression or expansion of the working medium, reduce dead space losses to a minimum and largely avoid flow losses of the fluids used (gases and liquids).

This task is solved by the device for converting thermal, mechanical and/or electrical energy quantities, the thermoelectric, thermomechanical or thermal converter and the computer-controlled or electronically controlled method for operating the thermoelectric, thermomechanical or thermal converter according to the independent claims. Further embodiments are disclosed in the sub-claims.

The present invention relates to a thermoelectric, thermomechanical or thermal converter in which a working medium, which at least partially contains a gas, can undergo a thermodynamic cyclic process and can be alternately compressed and expanded in the process. For example, this cyclic process can be a Stirling or Vuilleumier process, whereby in addition to the compression or expansion of the working medium, a phase transition of a component of the working medium from gaseous to liquid and from liquid to gaseous can also take place. The thermoelectric, thermomechanical or thermal converter can have a higher efficiency compared to the state of the art, as adiabatic losses, dead space losses and flow losses can be avoided, for example. Additionally, the converter enables a relatively simple to manufacture and correspondingly economical technical implementation, with which larger designs and higher outputs can also be achieved than with conventional solutions. Accordingly, applications that were previously not economically feasible may be possible. Due to the use of liquid directly in the compression and expansion spaces, which as a heat transfer medium can transport heat quantities directly into and out of the compression and expansion spaces, a very effective and fast heat transfer takes place between the liquid and the working medium, so that the converter is also very well suited for applications with low temperature differences to be used or generated.

The thermoelectric, thermomechanical or thermal converter comprises at least two volumes which are limited by volume delimiting elements and each contain at least one liquid quantity and at least one partial volume filled with an at least partially gaseous working medium, which are limited by volume delimiting elements and at least one surface of the liquid quantity, wherein this partial volume can be changed by the liquid and/or at least one volume delimiting element additionally being designed as a volume change element, wherein the volume change element can be displaced relative to other volume delimiting elements. One of these two volumes forms a so-called expansion space, the other a compression space. The partial volumes filled with working medium form the expansion and compression working spaces or the working spaces. An expansion space exists, for example, when the working medium is expanded and thus absorbs heat from its surroundings while it is in the working space. A compression space exists, for example, when the working medium is compressed, and thus releases heat to its surroundings while it is in the working space.

The volume delimiting elements or volume change elements can comprise openings or gas-permeable connections between different partial volumes for the inflow and outflow of the working medium into the partial volumes. The connections can contain additional heat exchanger elements or regenerators. Regenerators can be gas-permeable elements with a relatively large surface area and, for example, a high heat capacity, to which the working medium flowing past can quickly release heat quantities or absorb heat quantities from them. A regenerator can be made of steel wool or a porous metal structure, for example.

The volume delimiting elements are designed in such a way that they can prevent the liquid from flowing out to the inflow and outflow of liquid through small openings which serve to supply and discharge the liquid as a heat transfer medium to the outside (outside the device) in order to be able to use generated heat quantities outside the device or to be able to transport the heat quantities into the device, e.g. to drive the device, or a periodic displacement of the liquid quantity, provided this has the function of a volume change element.

The volume delimiting elements can be designed such that they prevent liquid from flowing out of the volumes or a flow of liquid between the volumes except for the liquid quantities intended for the supply and removal of heat quantities from/to outside the device.

In order to generate sufficiently high forces to keep the liquid quantities in their positions or spatial arrangements, for example preferred positions or preferred spatial arrangements, and to prevent liquid from being entrained or splashed around, for example when heat exchanger elements are immersed in and removed from the liquids, the volumes together with the liquid quantities they contain perform a rotational movement so that centrifugal forces act on the liquid quantities.

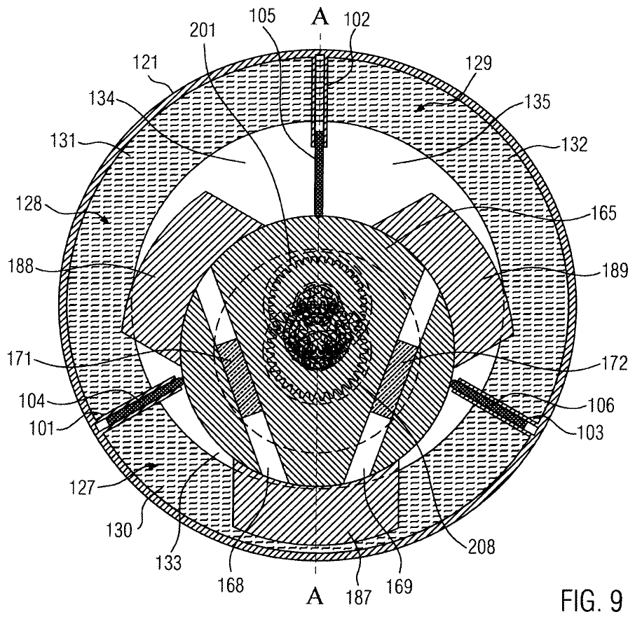

To improve the heat transfer between the liquid quantities and the working medium in the compression or expansion working space, heat exchanger elements are attached to at least one volume delimiting element (for example, to a volume change element), which are distributed as evenly as possible in the working space so that the working medium in the working space is very well thermally coupled to these heat exchanger elements. By periodically dipping the heat exchanger elements in and out of the liquid quantity, it is achieved that these are also very well thermally coupled to the liquid quantity and can thus effectively transfer heat quantities from the liquid quantity to the working medium and vice versa. In this way, a compression or expansion in the working spaces is largely isothermal. The heat exchanger elements can consist of thin rods, nets, sheets or plates. These are arranged, for example, in such a way that they have a lowest possible flow resistance when moving relative to the liquid. This also applies in the event that they not only move perpendicular to the surface of the liquid (immersion and removal movement), but also move transversely to the surface of the liquid. This can be the case, for example, when using a volume change element that rotates eccentrically in a water ring or segments of a water ring and thus the heat exchanger elements exert a circular movement or circular-like movement relative to the housing and relative to the liquid quantities (as an example, see the embodiment in FIGS. 9 to 12b). In this case, planar heat exchanger elements can be arranged parallel to the plane of this circular movement or circular-like movement.

The volume change elements and their movement relative to other volume delimiting elements and liquid quantities are designed in such a way that an almost complete displacement of the working medium in the working spaces is possible. The immersion of the heat exchanger in the liquid also ensures that hardly any dead space remains in the area of the heat exchanger elements or in the heat exchanger for the working medium, which could reduce the efficiency of the device.

In a first embodiment, at least one expansion space and at least one compression space together form a total volume which contains the respective at least one liquid quantity and the at least one partial volume of the compression space and the expansion space, wherein the total volume is subdivided by a volume change element into the individual compression and expansion spaces that are connected to one another by at least one gas-permeable connection. This gas-permeable connection can be part of the volume change element or be designed in a different way. The gas-permeable connection ensures that the pressure in the total volume is always largely the same throughout the total volume, even in the event of pressure changes in the total volume or changes in the size of the partial volumes in the individual compression and expansion spaces, thereby preventing flows of working medium other than through the connection provided for this purpose or flows of liquids between the various compression and expansion spaces. This also means that the volume change element does not have to be sealed by movable gas-tight sealing elements, such as piston rings or sealing strips, which would cause frictional losses. For example, this total volume can be completely gas-tight to the outside except for a connection to a pressure change element, which ensures a periodic pressure change in the total volume. Such a completely gas-tight seal to the outside can be achieved, for example, by using fixed volume delimiting elements or by using liquid quantities in gaps that are propelled outwards by centrifugal forces and can therefore withstand a higher gas pressure. Sealing elements such as shaft seals can also be used for a completely gas-tight seal to the outside.

In a second embodiment, this total volume comprises exactly one expansion space and exactly one compression space, which are bounded, amongst others, by a volume change element which executes a linear oscillating movement relative to the housing. In a third embodiment, this total volume comprises exactly one expansion space and exactly one compression space, which are bounded, amongst others, by a volume change element. The volume change element consists of a rotary piston which rotates eccentrically to the axis of rotation of other volume delimiting elements and liquid quantities, but at the same rotational speed, and separates the expansion and compression spaces from one another by volume delimiting elements mounted in the volume change element so as to move radially outwards. These volume delimiting elements, which are displaceably mounted in the volume change element, can be accelerated radially outwards, for example by centrifugal force, and can be limited in their movement by elements which are firmly connected to the housing and which simultaneously serve as volume delimiting elements for the compression space and the expansion space and, for example, protrude from the liquid quantities in a radially inward direction. In a fourth embodiment, the total volume comprises three working spaces, two of which are primarily used as an expansion space and the third primarily as a compression space, or two of which are primarily used as a compression space and the third primarily as an expansion space. In a fifth embodiment, this total volume comprises at least one group of expansion spaces and one group of compression spaces, which are bounded, amongst others, by a volume change element, wherein the change in volume of all expansion spaces of the group is synchronous (i.e. without phase shift), and wherein the change in volume of all compression spaces of the group is also synchronous.

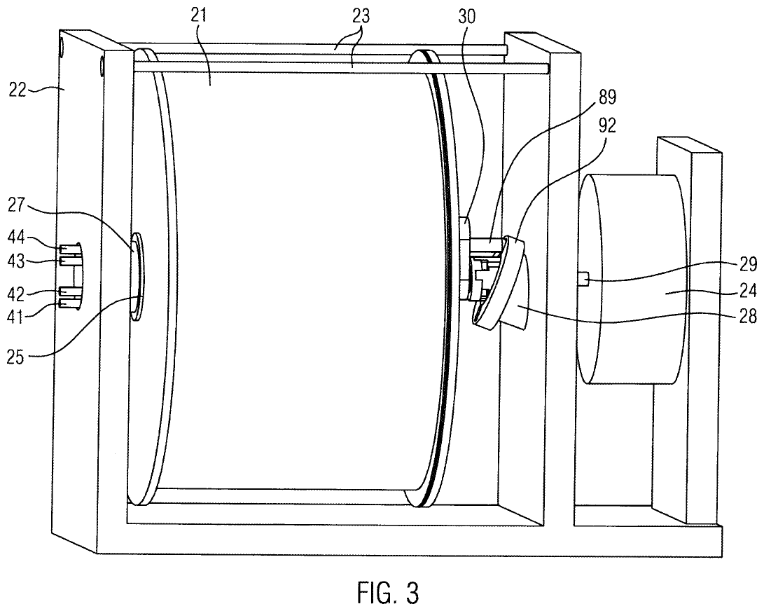

In a sixth embodiment, at least one volume change element or a volume delimiting element is designed such that it forms a hollow piston, the interior of which forms the working space filled with working medium, which is bounded on the one hand by the hollow piston and on the other hand by the liquid into which the hollow piston is immersed on the opening side. This hollow piston does not have to have a circular cross-section. For example, the opening of the hollow piston points radially outwards. When the hollow piston forms the volume change element which, as described above, divides a total volume into at least two volumes whose partial volumes filled with working medium are connected to each other in a gas-permeable manner, it can thus be ensured that the entire gas exchange between the partial volumes takes place by the gas-permeable connection provided for this purpose when the volume change element is displaced and not additionally through small gaps which are formed, for example, between the volume change element and other volume delimiting elements (see, for example, the embodiment in FIGS. 3 to 6).

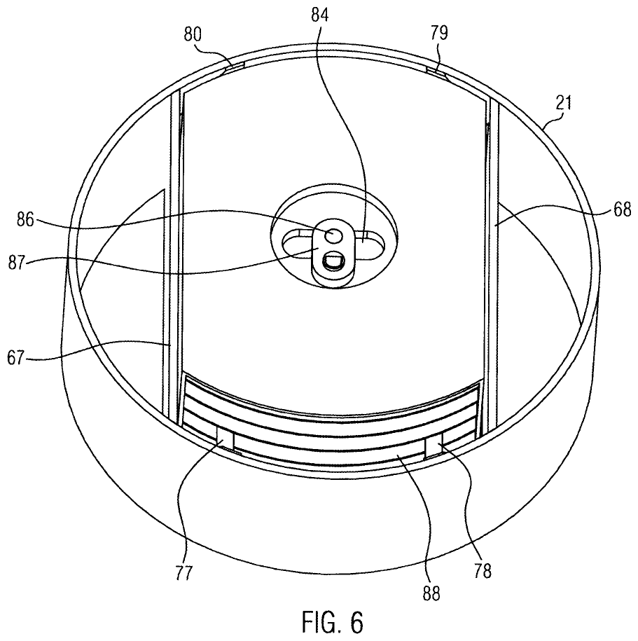

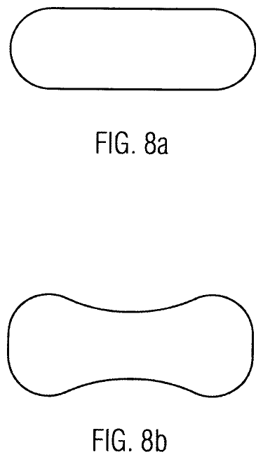

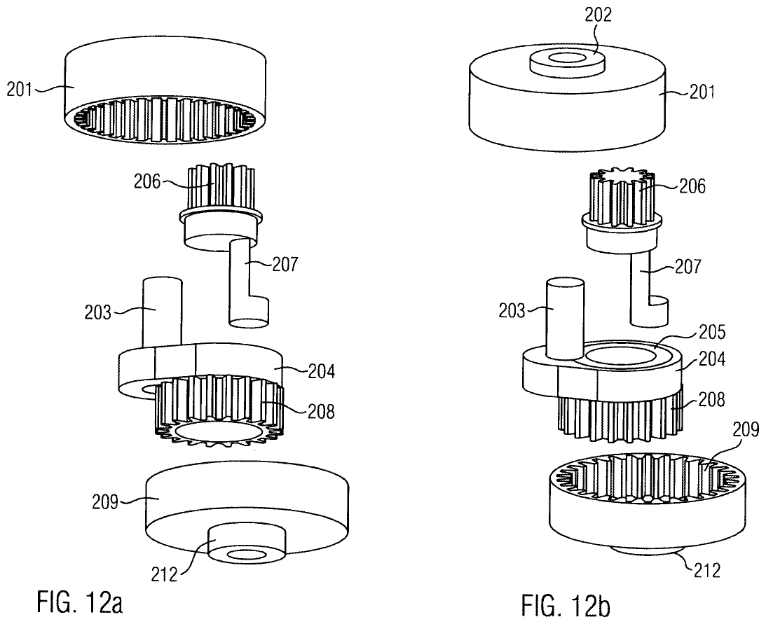

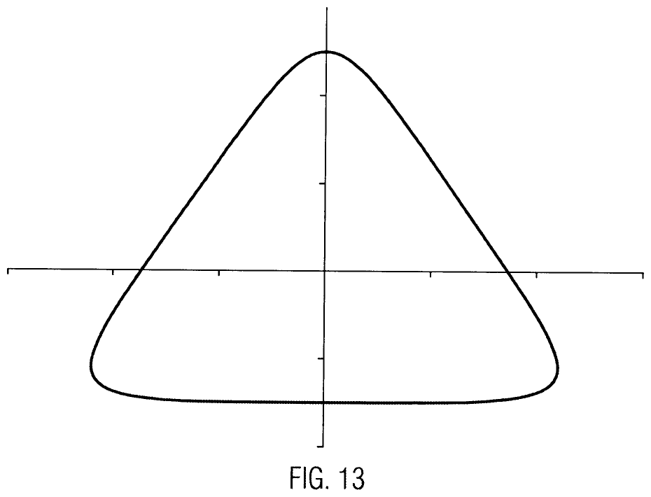

In a seventh embodiment, at least one volume change element performs an anharmonic movement which changes the volume of at least one working space in such a way that the volume change over time deviates from a sinusoidal curve. For example, the volume change element can cause a periodic volume change of the working space, which has at least two maxima and/or two minima per period of the second mathematical derivative of the course of the volume over time. Alternatively, the speed of the volume change when passing through the mean value of the volume can be at least 10%, for example at least 20% higher than in comparison to a sinusoidal curve. This can be achieved, for example, by actuating the volume change element by an actuating element mounted eccentrically to the axis of rotation of the housing, which is located in a recess of the volume change element with a correspondingly designed shape (as shown, for example, in FIG. 8b), and thus causes a non-sinusoidal translational movement of the volume change element relative to the housing, in contrast to a movement in a recess with a linear shape (as shown in FIG. 8a). Such an anharmonic volume change over time can serve to ensure that the working medium is located almost exclusively in the respective partial volume provided for this purpose during a compression or an expansion caused, for example, by an additional pressure change element, unlike would be the case with a harmonic (sinusoidal) progression of the volume change over time. Alternatively, an anharmonic movement of the volume change element can be represented, for example, by a gearing which comprises an element which, relative to other volume delimiting elements, executes a movement about the axis of rotation of these volume delimiting elements which deviates from a circular shape (as shown, for example, in Fig. in FIG. 13), wherein the gearing can have the structure of FIGS. 12a and 12b and the element in this case would be the axle 207, in which case the gear 208, the internal gear 209 and the bearing 212 can be dispensed with, and wherein this element is mechanically coupled to the volume change element by a connecting rod or by an actuating element which can move in a recess of the volume change element (as shown, for example, in FIGS. 6, 8a, 8b), or otherwise.

An eighth embodiment comprises exactly three or at least three volumes, each with at least one partial volume, whereby the partial volumes are connected to each other in a gas-permeable manner and thus form a total volume with largely the same pressure everywhere. The gas-permeable connections can contain additional heat exchangers or regenerators. With this arrangement, a Vuilleumier process can be realized, for example, or a Vuilleumier process with an additional pressure change element to amplify the pressure changes occurring within the working spaces. The changes in size of the at least three partial volumes can be caused by a volume change element that limits all three partial volumes. In contrast to other rotary piston machines or a principle related to the Wankel motor, the volume change element does not rotate completely relative to the housing, which avoids shift losses. Additionally, displaceable volume delimiting elements can limit the volumes and partial volumes, which are always brought into a position by springs, buoyancy forces in liquid, magnetic forces or other forces that completely limit the volumes and partial volumes down to the smallest gaps. There is little or no flow of working medium or liquid through these smallest gaps, as the same or approximately the same pressure prevails on both sides of the gaps, which is ensured by the fact that the partial volumes are connected to each other in a gas-permeable manner. These displaceable volume delimiting elements are similar to those from the third embodiment, whereby in the eighth embodiment they are displaceably mounted in corresponding elements (e.g. shafts) which are firmly connected to the housing, and in the third embodiment they are displaceably mounted in corresponding elements (e.g. shafts) which are firmly connected to the volume change element. The volume change element can perform a rotational movement about an axis of rotation that deviates from the axis of rotation of the liquid quantities and other volume change elements, thus causing the volume change. Additionally, the axis of rotation of the volume change element can change its position, for example, by performing a circular movement or another movement. In this way, non-circular movements of the volume change element relative to other volume delimiting elements or liquid quantities can be realized, as shown, for example, in FIG. 13. Thus, a temporal progression of the variables of the partial volumes is representable which deviates from a sinusoidal shape or which is advantageous for the respective thermodynamic cycle, for example.

The displaceable volume delimiting elements of the third and eighth embodiments can each be designed and arranged in such a way that they do not perform a movement in liquid quantities relative to the liquid quantities that have a movement component perpendicular to their movement relative to the elements in which they are displaceably mounted—they thus possibly only dip in and out of the liquid quantities, but do not displace the liquid quantities perpendicular to this dipping in/dipping out movement. In the third embodiment, this is achieved by the displaceable volume delimiting elements not being dipped in the liquids, but being limited in their radial movement by elements that protrude from the liquid quantities when viewed in the radial direction. In the eighth embodiment, this is achieved in that the displaceable volume delimiting elements can be mounted in such a way that they also move relative to the liquid quantities only in the direction which also corresponds to the direction of their displacement relative to the elements in which they are displaceably mounted.

The device includes the option of supplying heat quantities directly by liquid quantities as a heat transfer medium or indirectly by heat exchangers between the liquid quantities in the volumes and other liquid quantities in at least one of the volumes and removing it from this volume. In order to avoid, for example, pressure changes in the volume and partial volumes therein as well as flow losses of the liquid, very small openings are provided for the supply and discharge of the liquid, which only allow a very small part of the total liquid quantity of the volume to flow through them per period, namely max. 5% of the liquid quantity, for example max. 2%, or for example max. 1%. For example, at least one of these openings connects at least one volume with a further annular volume, in which a liquid ring can form, from which liquid can be discharged to the outside by a tube or similar element projecting into the liquid ring. The tube or similar element can also regulate the height of the liquid ring and thus also the liquid quantity in the volume. Alternatively to these openings, heat quantities can be fed into or removed from the volumes by thermally coupling the liquid quantity within a volume by a heat exchanger to liquid quantities that are also located outside the volume, e.g. in a liquid ring, from which they can also be removed to the outside by a pipe or similar element projecting into the liquid ring.

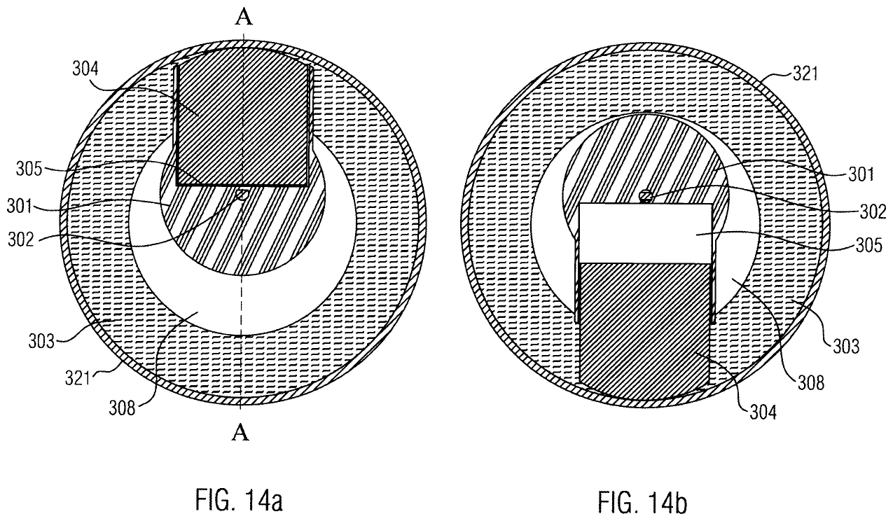

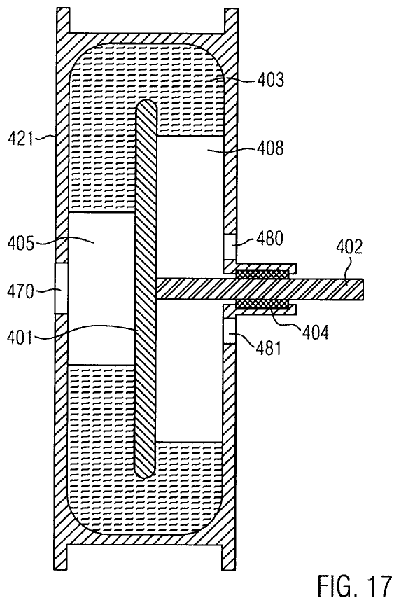

To implement a thermodynamic cycle, the volumes can be connected to an additional pressure change element. For example, the partial volumes can be connected to a pressure change element in a gas-permeable manner. This pressure change element can seal the total volume, which it forms with the partial volumes, completely tightly to the outside. It can be designed as a diaphragm compressor or diaphragm piston, for example, which can consist of an expandable diaphragm and a diaphragm spring. Alternatively, it can be designed as an oscillating water column or as an oscillating water ring, as shown in FIG. 17, for example. A ninth embodiment comprises a pressure change element consisting of a rotating element which rotates eccentrically to the housing or to the axis of rotation of the liquids. This rotating element contains a further element movably mounted therein, which is thrown outwards by the centrifugal force of the rotation and is thereby limited in its movement by the housing or another element and thus periodically changes a volume between the rotating element and this additional element. The rotating element and the additional element mounted therein can be partially immersed in a water ring which can seal the gaps between the two elements (see FIGS. 14a, 14b, 15, 16). Alternative embodiments of the pressure change element are, for example, a piston or hollow piston oscillating in a cylinder, whereby the gaps can be sealed by water on which a centrifugal force acts. Alternatively, the pressure change element can also be designed in such a way that it periodically displaces a liquid quantity which, as a volume change element, periodically changes the size of at least one partial volume.

The device can be used to realize a thermodynamic cycle, e.g. a Stirling process, a Vuilleumier process, a duplex Stirling process, an Ericsson process, a Joule process or a Clausius-Rankine process or a combination of these processes. In particular, it is suitable for implementing a Stirling process of the Beta or Gamma type, in which, on the one hand, a volume change element is used which alternately moves a working medium back and forth between a compression space and an expansion space without generating a significant change in pressure except for effects from flow resistance, and in which an additional pressure change element causes the change in pressure within the working spaces. In its function as a heat engine, the pressure change occurring in the machine can also drive the pressure change element. By implementing a Stirling process, for example, the function of a heat pump or a heat engine can be realized. In this case, the device forms a thermoelectric or thermomechanical converter. If two Stirling processes are coupled together in such a way that one operates as a heat pump and the other as a heat engine, heat quantities of certain temperatures can also be converted into heat quantities of certain other temperatures. This is referred to here as the duplex Stirling process. In this case, it functions as a thermal converter. An application as a Vuilleumier process or as a Vuilleumier process with an additional pressure change element also allows the function of a thermal converter. However, both when implementing a duplex Stirling process and when implementing a Vuilleumier process with an additional pressure change element, it is also possible to operate the device flexibly as required as a thermoelectric, thermomechanical or thermal converter, which can generate heat, cold, mechanical energy or electrical energy flexibly and as required, and which can use heat, cold, mechanical energy or electrical energy flexibly for this purpose.

The thermodynamic cycle can be operated such that little or no evaporation and condensation of the liquid takes place in the volumes, or that this evaporation and condensation has a significant influence on the thermodynamic cycle. For example, a Stirling or Vuilleumier process can be represented in which, in addition to the compression and expansion of the working medium in the working spaces, liquid quantities are also evaporated and condensed and thus also contribute to the pressure change in the system.

A more detailed description of the function of the device for an exemplary implementation of the Stirling process and the Vuilleumier process is provided below as part of the explanation of the figures.

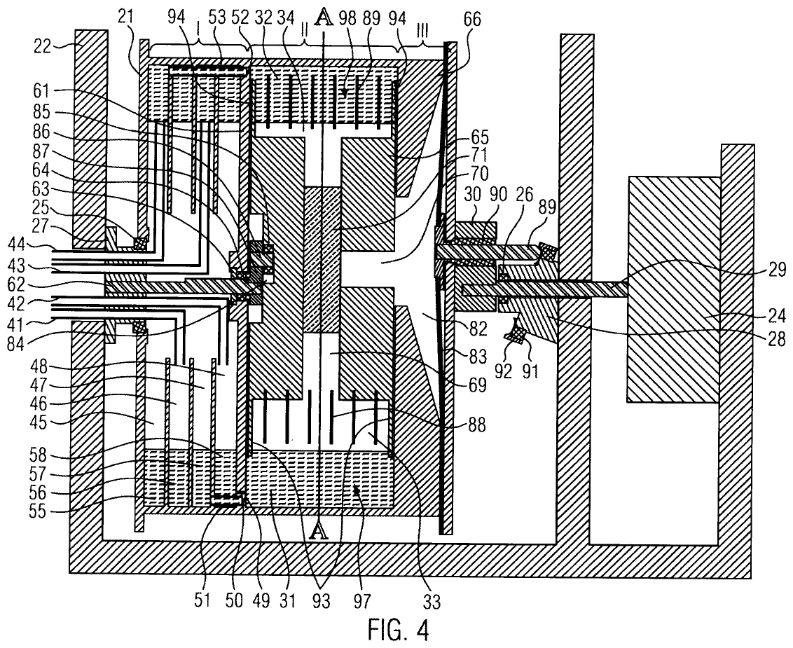

The working medium inside the device can have a pressure that can be higher than the ambient pressure. This allows the performance to be increased. For this purpose, the effect can be used that when the device is being filled with liquid, the openings are completely surrounded by liquid and the working medium can no longer escape from the interior of the device so that it is compressed and its pressure increases. In this case, different liquid levels relative to the housing wall form in the liquid exchange unit (segment I in FIG. 4) and in the displacement unit (segment II in FIG. 4). Alternatively or additionally, working medium and/or liquid can be fed into the device at an overpressure through openings (e.g. in the fixed axis 62 in FIG. 4). Alternatively, the entire device can also be additionally enclosed with a pressure vessel, which is provided with an overpressure.

The device may additionally include valves or orifices that open or close when pressure changes or when volume change elements move relative to other volume delimiting elements or liquid quantities.

Elements and aspects of the various embodiments mentioned can be partially or completely combined.

In addition, a computer-controlled or electronically controlled method for operating a thermoelectric, thermomechanical or thermal converter, as described above or further below, is provided.

In the longitudinal and cross-sectional views shown, only those elements are shown (with hatching) that lie in the sectional plane. An exception is the sectional view in FIG. 9, in which parts of the drive unit that are not in the sectional plane are also shown by lines, as well as the sectional view in FIG. 17, in which openings are shown with dashed lines.

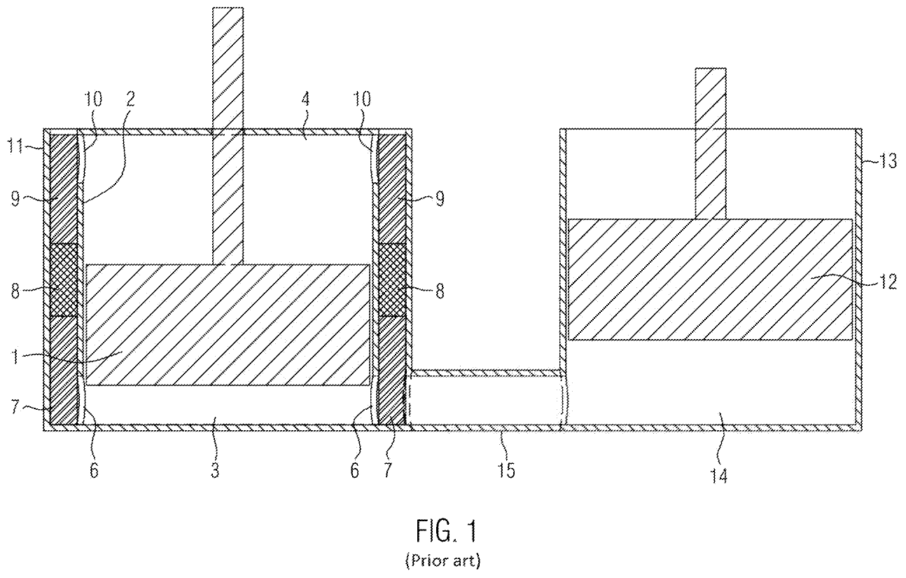

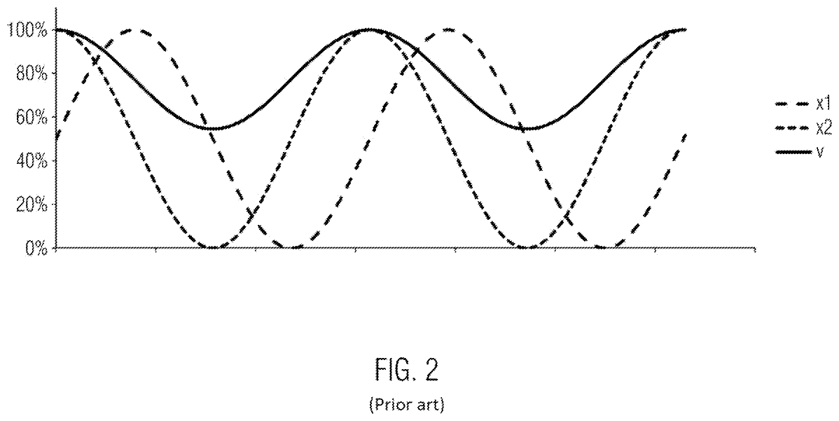

In the following, the principle of a Stirling engine of the Gamma design according to the state of the art is explained with reference to FIG. 1. Through its oscillating movement in the cylinder 2, the displacement piston 1 shifts the working medium alternately from the compression working space 3 to the expansion working space 4 and vice versa. The working medium flows through the openings 6, the heat exchanger 7, the regenerator 8, the heat exchanger 9 and the openings 10 (or vice versa). The working medium gives off heat to the heat exchanger 7 or, when flowing in the opposite direction, it absorbs heat from the heat exchanger 9. The heat exchangers 7, 9 are each thermally coupled to external heat sources or sinks. The outer housing 11 prevents the working medium from leaving the system or pressure equalization with the volume outside the device. The working piston 12, which performs an oscillating movement in the cylinder 13 that is out of phase with the movement of the displacement piston 1, changes the pressure inside the device, i.e. also in the compression working space 3 and in the expansion working space 4. For this purpose, the volume 14 is connected to the compression working space 3 and the expansion working space 4 by the connecting element 15 in a gas-permeable way. A reduction in volume and increase in pressure takes place due to the phase shift of the two pistons 1, 12, while the working medium is predominantly located in the compression working space 3. Consequently, the working medium is predominantly heated there. An increase in volume and reduction in pressure takes place while the working medium is predominantly located in the expansion working space 4, and the working medium is therefore predominantly cooled there. However, as part of the working medium is always located in the heat exchangers 7, 9 and in the regenerator 8, expansion and compression, which is detrimental to efficiency, also takes place there to some extent. This volume is therefore also referred to as dead space. As the working medium in the compression working space 3 and in the expansion working space 4 is not in contact with the heat exchanger, compression and expansion largely take place adiabatically, which is also detrimental to efficiency. Another disadvantage is that with a harmonic (sinusoidal) movement of the pistons 1, 12 during compression and expansion, a part of the working medium is usually in the wrong space. This can be seen in FIG. 2: It shows the time curve of the harmonic movement of the displacement piston 1 (line x1) and the working piston 12 (line x2) as well as the time curve of the total volume within the device (line V).

FIGS. 3 to 6 disclose elements of the sixth embodiment, which is a Stirling machine. The housing 21 is rotatably mounted in the frame 22 by the ball bearings 25 and 26, wherein the bearing blocks 27 and 28 are fixedly connected to the frame 22, as are the tension pick-up rods 23. The housing 21 is mechanically coupled to the motor/generator 24 by the axis of rotation 29 of the motor/generator 24 and the axis mount 30, so that the motor/generator 24 can drive the housing 21 or can be driven by it.

Within the housing 21, the device is divided into 3 segments, which are marked in FIG. 4 with curly brackets and Roman numerals I-III: The first segment (labeled I) is used to feed liquid quantities from the outside into the volumes 97, 98 and to discharge liquid quantities from the volumes 97, 98 to the outside. It is also referred to as a liquid exchange unit. The second segment (marked II) comprises the two volumes 97 and 98, which contain the liquid quantities 31, 32, the working spaces 33 and 34 filled with working medium and the volume change element 65. It is also referred to as the displacement unit. The third segment (marked III) comprises the pressure change element 83 and is also referred to as the pressure change unit.

The function of the liquid exchange unit (segment I) is described first. Liquid quantities can be fed into the liquid chambers 46 and 48 by feed pipes 41 and 42, where they each form a liquid ring 56, 58. A small volume flow from the liquid ring 58 can flow through the opening 49 into the volume 97. A small volume flow can flow from the liquid ring 56 through a pipe connection (not shown in this longitudinal section) into the volume 98. Liquid from the volume 97 can flow through the opening 50 and through the pipe 51 into the chamber 47, in which a liquid ring 57 is also formed. Part of the liquid quantity can flow out of the chamber 47 to the outside by the outlet pipe 43, whereby the length of the part of the outlet pipe 43 pointing radially outwards regulates the filling level of the liquid ring 57. Liquid can also flow from the volume 98 through the opening 52 and the tube 53 into the chamber 45, where the liquid ring 55 is located. From there, some of the liquid can leave the device to the outside via the outlet pipe 44. The inlet pipes 41, 42 and the outlet pipes 43, 44 are firmly connected to the bearing block 27.

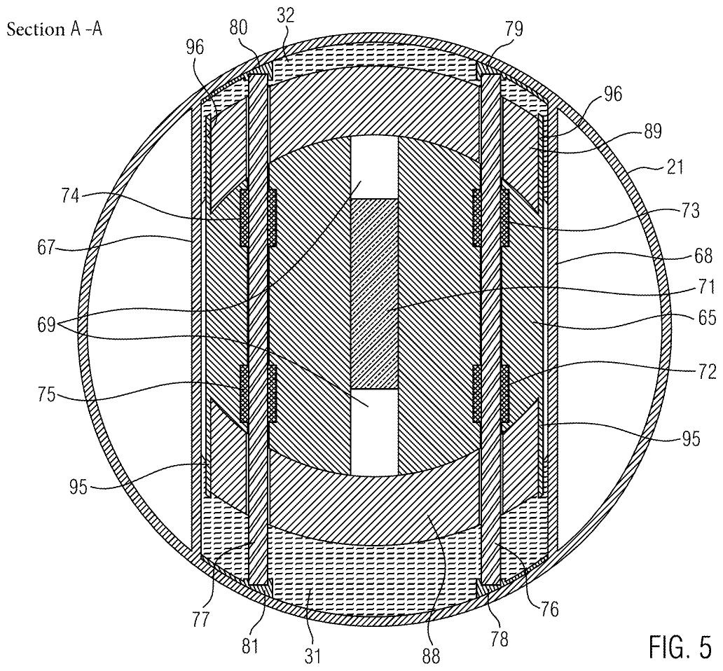

Segments II and III comprise a total volume filled at least partially with gaseous working medium (e.g. air), which comprises the working spaces 33, 34 and the interior 82 of the pressure change unit. This total volume is completely sealed gas-tight to the outside, as it is completely enclosed by the housing 21 with its partition wall 61 and the movable and gas-tight diaphragm compressor unit 83. Only the fixed shaft 62, which is firmly connected to the bearing block 27 and is therefore immovable, protrudes through an opening in the partition wall 61 into the interior of segment II and is sealed to the outside by a shaft seal 63. The partition wall 61 is rotatably mounted about the fixed axis 62 by the ball bearing 64. The working space 33 is limited by the following volume delimiting elements: The liquid quantity 31, the housing 21 with its partition wall 61 and its eccentric funnel element 66, the lateral partition walls 67, 68 (see FIG. 5) and the volume change element 65. The working space 34 is limited by the following volume delimiting elements: The liquid quantity 32, the housing 21 with its partition wall 61 and its eccentric funnel element 66, the lateral partition walls 67, 68 (see FIG. 5) as well as the volume change element 65. The working spaces 33, 34 are connected to each other in a gas-permeable manner by the opening 69 in the volume change element 65, as well as by the opening 70 to the interior 82 of the pressure change unit. The opening 69 contains the gas-permeable regenerator 71.

The volume change element 65 is designed and mounted in such a way that it can perform a linear back and forth movement relative to the housing and can thus change the size of the working spaces 33, 34. For this purpose, it is displaceably mounted on the two axes 76, 77 by linear bearings 72, 73, 74, 75, which are firmly connected to the housing 21 by fastening elements 78, 79, 80, 81. This mounting ensures that the volume change element 65 does not touch the housing 21 with the partition wall 61 and the funnel element 66 as well as the partition walls 67, 68, thereby avoiding sliding friction. The movement of the volume change element 65 is caused by the fact that it is mechanically coupled by the recess 84 to the actuating element 85, which is formed by a ball bearing and can move back and forth in the recess 84. The actuating element 85 is connected by the axle 86 to the eccentric 87, which in turn is firmly connected to the immovable axle 62. The axle 62 is firmly connected to the bearing block 27. Therefore, the actuating element 85 remains immobile in its position while the housing 21 together with the volume change element 65 performs a rotational movement. The limitation imposed by the recess 84 on the actuating element 85 in its movement relative to the volume change element 65 causes a linear movement of the volume delimiting element 65 relative to the housing 21: during each complete rotation of the housing 21 about its axis, the volume change element 65 moves back and forth once along the axes 76, 77. This ensures that the working spaces 33, 34 are alternately reduced and enlarged, and that the working medium flows back and forth through the opening 69 between the working spaces 33, 34 and thereby flows through the regenerator 71. In the process, the heat exchanger elements 88, 89 are each alternately dipped in the liquid quantities 31, 32 and dipped out from them again, and are thus alternately in thermal contact with the liquid quantities 31, 32 and with the working medium contained in the working spaces 33, 34.

While the working medium is largely completely located in one of the working spaces 33, 34 (and the volume change element 65 thus displaces it from the other of the working spaces 33, 34), it is compressed, as a result of which it heats up. While it is largely completely in the other of the working spaces 33, 34, the working medium is expanded, causing it to cool. This compression and expansion is caused by the diaphragm compressor element 83, which is connected to the working spaces 33, 34 by the openings 69, 70 in a gas-permeable manner. It consists of an expandable diaphragm (e.g. a rubber disk) and a diaphragm spring. It is alternately pressed into the interior 82 and released again by the plunger 89, which is mounted in the axle mount 30 by the linear bearing 90 so that it can move eccentrically to the axle 29. The movement of the plunger is caused by the fact that it touches the swash plate 92, which is rotatably mounted on the bearing block 28 by the ball bearing 91. The function of the funnel element 66 is to avoid superfluous dead space and its shape therefore simulates the shape of the diaphragm compressor element 83, which is pressed completely inwards.

The sides of the volume change element 65 facing the liquid quantities 31, 32, which limit the working spaces 33, 34, have the shape of a hollow piston, since the volume change element 65 comprises respective end extensions 93, 94 and lateral extensions 95, 96, which are immersed to different depths in the liquid quantities 31, 32 during the movement of the volume change element 65 relative to the housing 21. They prevent the working medium from flowing back and forth between the working spaces 33, 34 through the gaps surrounding the volume change element 65, so that this is only possible through the opening 69.

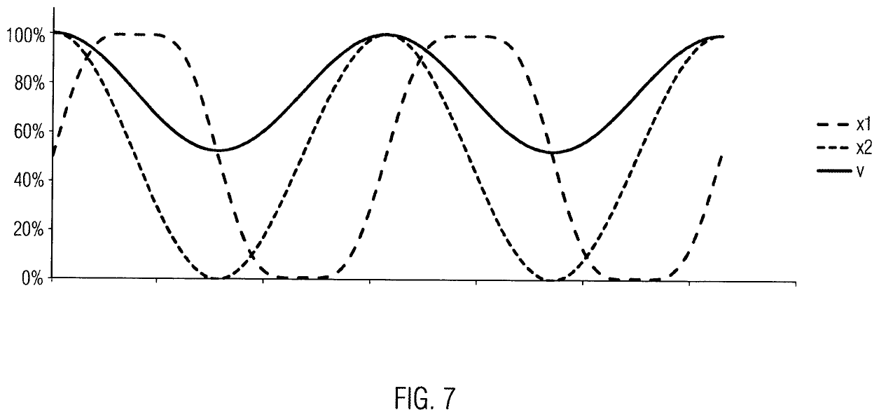

In order to improve the efficiency of the sixth embodiment shown in FIGS. 3 to 6 or of Stirling machines of the beta or gamma design in general, a non-sinusoidal movement of the volume change element 65 over time (or the so-called “displacement piston” of a Stirling machine) can be aimed for, as shown by the line “x1” in FIG. 7. The diaphragm compressor unit 83 (or the so-called “working piston” of a Stirling engine) can also have a sinusoidal curve, as shown by the line “x2” in FIG. 7, which leads to a curve of the total volume corresponding to the line “V”. A non-sinusoidal course of the movement of the diaphragm compressor element or working piston corresponding to line “x1”, but out of phase with the volume change element 65 or displacement piston, is also conceivable. Both additionally reduce dead space, i.e. the presence of working medium outside the expansion working space during an expansion or outside the compression working space during a compression. In the sixth embodiment shown in FIGS. 3 to 6, this can be achieved for the volume change element 65 in such a way that the recess 84 does not have the shape shown in FIG. 8a, but a shape as shown in FIG. 8b. Alternatively, an anharmonic movement of the volume change element 65 can be achieved, for example, by mechanically coupling it by a connecting rod to an axis which performs a non-circular movement relative to the housing 21, this movement being similar to that in FIG. 13 with the difference that it has a four-cornered instead of a three-cornered rotational symmetry, i.e. corresponds to a square with rounded corners. This axle may be part of a gearing such as that of FIGS. 12a and 12b, in which case the axle would be axle 207, in which case gear 208, internal gear 209 and bearing 212 may be omitted. Alternatively, the axle can also be mechanically coupled to the volume change element 65 by an actuating element connected thereto and by a recess in the volume change element 65.

FIGS. 9, 10, 11, 12a, 12b disclose an alternative embodiment of the invention, which is identical to the sixth embodiment shown in FIGS. 3 to 6 except for the displacement unit (segment II in FIG. 4), which is replaced by the displacement unit shown in FIGS. 9 to 12b, and except for a modification of the liquid exchange unit (segment I in FIG. 4), which contains 6 instead of 4 different chambers, 3 of which are provided for the inflow of liquid quantities into the volumes 127, 128, 129 by corresponding openings (e.g. 149) and the 3 other for the outflow of liquid quantities from the volumes 127, 128, 129. This alternative embodiment forms a Vuilleumier machine which can amplify the pressure change within the Vuilleumier machine with the pressure change unit (segment III in FIG. 4).

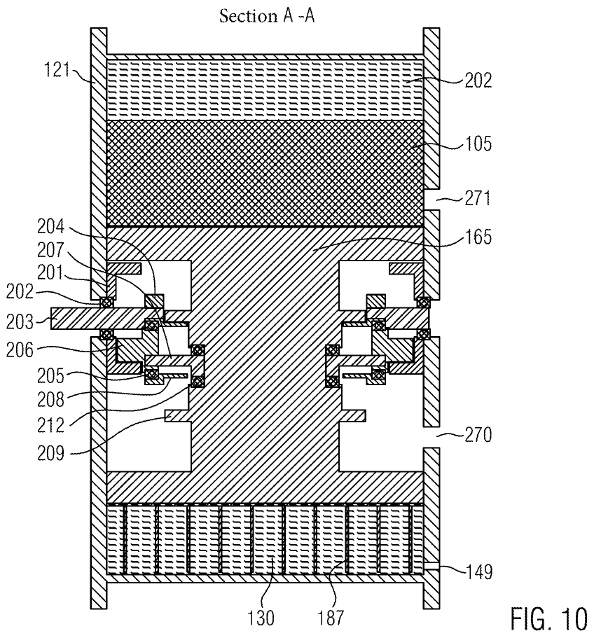

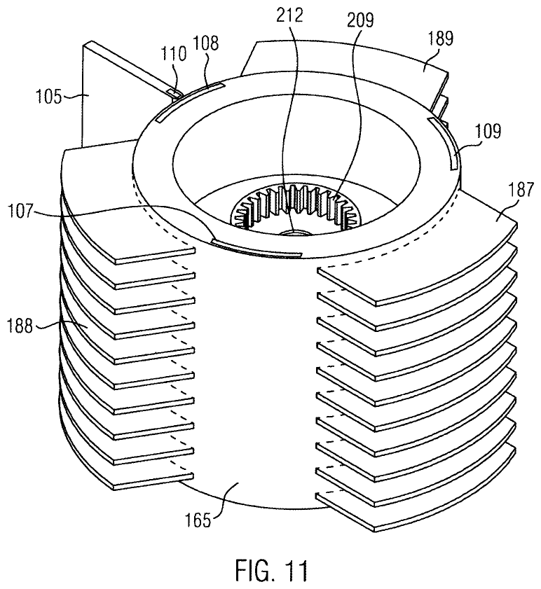

FIG. 9 shows a cross-section of the displacement unit. It comprises three volumes 127, 128, 129, which are bounded respectively by the housing 121, by the slide shafts 101, 102, 103, by the slides 104, 105, 106 and by the volume delimiting element 165. The volume 127 comprises the liquid quantity 130 and the working space 133 filled with working medium. The volume 128 comprises the liquid quantity 131 and the working space 134 filled with working medium. The volume 129 comprises the liquid quantity 132 and the working space 135 filled with working medium. The slides 104, 105, 106 are movably mounted in the slide shafts 101, 102, 103 and are pressed radially inwards by spring elements (not shown here) or by radially inwardly directed buoyancy forces, which act on the slides 104, 105, 106 by liquid, or by magnetic forces between the slides 104, 105, 106 and the volume change element 165 in such a way that they always contact the volume change element 165 and thus also limit the volumes 127, 128, 129. Buoyancy forces are generated in that the slides 104, 105, 106 have a lower density than the liquid used and the slide shafts 101, 102, 103 are also filled with liquid (see liquid quantity 202 within the slide shaft 102 in FIG. 10). The slide shafts 101, 102, 103 are each connected to one of the volumes 127, 128, 129 by liquid-permeable openings (not shown here). FIG. 11 shows ferromagnetic elements 107, 108, 109, which are located close to the points in the volume change element 165 where the slides 104, 105, 106 contact them, as well as a magnetic element 110 in one of the slides 105, which generates an attractive force of the slide 105 in the direction of the volume change element 165.

The working spaces 133, 134, 135 are connected to one another in a gas-permeable manner by the openings 168, 169, wherein the openings 168, 169 each contain a gas-permeable regenerator 171, 172.

The volume change element 165 performs a rotational movement about an axis of rotation which is parallel to the axis of rotation of the housing 121 but offset from the housing axis, wherein this rotational movement is superimposed by a circular movement of the axis of rotation of the volume change element 165. The movement of the volume change element 165 relative to the housing 121 has a shape as shown in FIG. 13. This movement of the volume change element 165 is caused by two gears by which the volume change element 165 is mechanically coupled to the rotating housing 121, and which are shown in FIG. 10 as a cross-section and in FIG. 12a and FIG. 12b as a 3D exploded view. For the sake of simplicity, the individual parts of only one of the two gears are labeled in FIG. 10—the other is of identical design. The internal gear 201 is firmly connected to the housing 121. The non-rotating axle 203 is firmly connected to the fixed eccentric 204 and is rotatably mounted relative to the housing 121 in the ball bearing 202, which can be sealed by an additional shaft seal (not shown here). The eccentric 204 comprises the ball bearing 205, in which the gear element 206 is rotatably mounted. The rotation of the gear element 206 is mechanically coupled to the rotation of the housing 121 by the teeth of its gear wheels and the gear wheels of the internal gear wheel 201. The axle 207 is firmly connected to the gear element 206, whereby it is arranged eccentrically to the center axis of the gear element 206. It is rotatably mounted in the ball bearing 212, which is connected to the internal gear 209 and the volume change element 165, wherein the internal gear 209 is also fixedly connected to the volume change element 165. The internally hollow gear 208 is fixedly connected to the eccentric 204 and couples the rotation of the volume change element 165 about its own axis with its rotation about the axis 207 by the teeth of the gear 208 engaging with the teeth of the internal gear 209.

Alternatively to the form of movement shown in FIG. 13, the volume change element 165 can also perform a simple circular movement relative to the housing 121. For this third or eighth embodiment, the volume change element 165 is rotatably mounted eccentrically relative to the axis of rotation of the housing 121 and is mechanically coupled to the housing 121 by an alternative gearing such that it has the same rotational speed as the housing 121. Alternatively to the circular form of movement of the volume change element relative to the housing in the third embodiment, the form of movement of the volume change element relative to the housing or to other volume delimiting elements and liquid quantities can also have a form with four-fold rotational symmetry (in contrast to the three-fold rotational symmetry of FIG. 13), which thus largely resembles a square with rounded corners.

The movement of the volume change element 165 relative to the rotating housing 121 ensures that the working spaces 133, 134, 135 are alternately reduced and enlarged out of phase with each other, whereby the working medium contained therein is displaced back and forth between the working spaces 133, 134, 135 through the openings 168, 169 and thereby flows through the regenerators 171 and 172. Since the working medium in the working spaces 133, 134, 135 is thermally coupled by the heat exchanger elements 187, 188, 189 to the liquid quantities 130, 131, 132, which can have different temperatures, it can be alternately heated and cooled, causing pressure and temperature changes in the working medium. In this way, the working medium can change its temperature and thus its pressure when flowing from one working space (e.g. 133) into another working space (e.g. 134), which also changes the pressure and temperature of the part of the working medium located in the third working space (e.g. 135), which thereby changes its temperature and passes this temperature change on to the liquid quantity (e.g. 132) thermally coupled to it. In this way, the function of a Vuilleumier machine can be achieved, which consists of using the temperature difference between two heat transfer media (e.g. 130, 131) to heat or cool a third heat transfer medium (e.g. 132). This function can be enhanced by using the additional pressure change unit (segment III of FIG. 4) to increase the pressure change. For this purpose, the interior 82 of the pressure change unit (segment III of FIG. 4) is connected to the working spaces 133, 134, 135 by the openings 270, 271 in a gas-permeable manner.

FIG. 11 shows a 3D view of the volume change element 165 with the heat exchanger elements 187, 188, 189 connected to it and the ferromagnetic elements 107, 108, 109. Of the sliders 104, 105, 106, only the one slider 105 with its magnetic element 110 is shown here. There is an attractive force between the magnetic element 110 and the ferromagnetic element 108, which keeps the slider 110 continuously in contact with the volume change element 165.

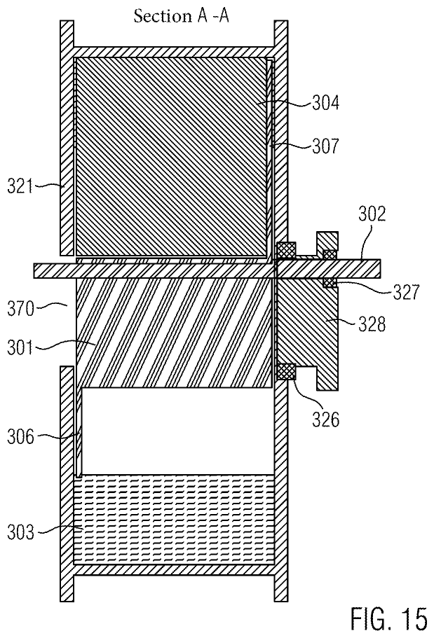

FIGS. 14a, 14b, 15, 16 show the ninth embodiment with a pressure change unit that can be used instead of the pressure change unit shown in FIG. 4 (segment III in FIG. 4). FIG. 14a shows a cross-section through the pressure change unit. A rotor 301, which is mounted eccentrically to the housing and is driven by the shaft 302, rotates in the rotating housing 321. The rotor 301 comprises a shaft in which the centrifugal piston 304 is movably mounted and which is always immersed in the liquid ring 303. As the rotor 301 rotates about its axis 302, the distance between the shaft and the housing 321 changes periodically, so that the centrifugal piston 304, which is accelerated radially outwards by centrifugal forces and is limited in its movement by the housing 321, periodically changes the volume of the compression and expansion space 305. The compression and expansion space 305 is coupled to the working spaces of the displacement unit (segment II in FIG. 4) by the opening 370 (see FIG. 15) in a gas-permeable manner, whereby a corresponding compression and expansion of the working medium is generated there. FIG. 14a shows the position of the rotor 301 at which the volume of the compression and expansion space 305 is minimal, FIG. 14b shows the position of the rotor 301 at which this volume is maximum.

FIG. 15 shows a sectional view along the sectional axis A-A from FIG. 14a. The axle 302 is mounted eccentrically to the housing 321 by the ball bearing 327 in the bearing block 328. The housing 321 is rotatably mounted by the ball bearing 326. A motor/generator (not shown here) is coupled to the rotor 301 by the axle 302. The rotor 301 can be mechanically coupled to the housing 321 so that both have the same rotational speed. This coupling may consist of a gearing (not shown here) or by a coupling of the centrifugal piston 304 with an element (not shown here) projecting inwards from the cylindrical outer wall of the housing 321.

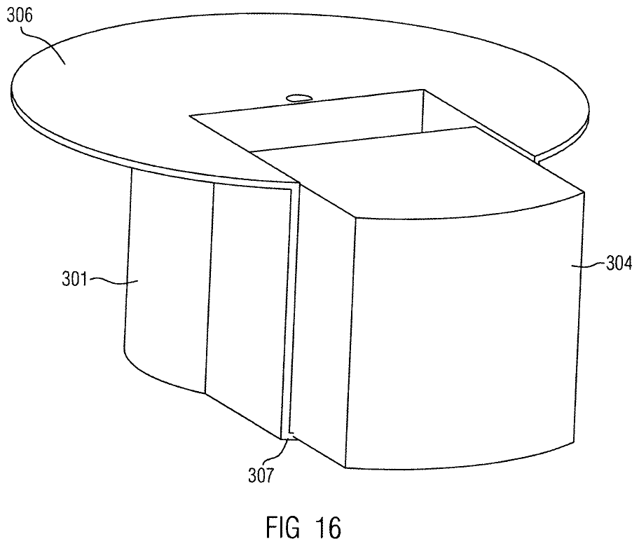

FIG. 16 shows a 3D view of the rotor 301 and the centrifugal piston 304. It can be seen in FIG. 15 and in FIG. 16 that the rotor 301 comprises sealing elements 306, 307 which are continuously immersed in the liquid ring 303 and thus ensure that the volume 305 is completely sealed to the volume 308 and to the outside. The fluid in the gaps between the shaft of the rotor 301 and the centrifugal piston 304 also contributes to this seal. The shaft 302 may be used in place of the fixed shaft 62 of FIG. 4 and the eccentric 87 of FIG. 4 to receive an actuator element 85 of FIG. 4 to cause movement of the volume change element 65 of FIG. 4, or alternatively a connecting rod may be attached thereto that is connected to a volume change element 65 to cause movement thereof. The volume 308 may be connected to the environment by openings in the housing 321.

FIG. 17 shows a further alternative embodiment of a pressure change unit (segment III in FIG. 4). A liquid ring 403 is located in the housing 421, into which the vibration excitation element 401 is immersed. The vibration excitation element 401 separates the two volumes 405 and 408, whereby the volume 405 is connected to the working spaces of the displacement unit (segment II in FIG. 4) in a gas-permeable manner by the opening 470. The volume 408 is connected to the environment by the openings 480, 481 in a gas-permeable manner. The vibration excitation element 401 is movably mounted in the housing 421 by the axle 402, which is fixedly connected to it, and by the linear bearing 404. By moving the vibration excitation element 401 back and forth, the liquid ring 403 can be set into a displacement vibration, whereby the liquid ring 403 alternately reduces and increases the volume 405 and simultaneously increases and reduces the volume 408. The excitation of this displacement oscillation is particularly effective when it occurs in the range of the natural frequency of the displacement oscillation of the liquid ring 403. Since the volume 405 is connected by the opening 470 to the working spaces of the displacement unit (segment II in FIG. 4) in a gas-permeable manner, the compression and expansion of the working medium in these working spaces can thus be accomplished.

A pressure change unit as shown in FIG. 17 can also be used to mechanically couple two different displacement units (segment II in FIG. 4) with each other. For this purpose, the vibration excitation element 401 does not necessarily have to be movable, but can alternatively form a fixed partition wall between the volumes 405, 408. The volume 405 is connected in a gas-permeable manner to the working spaces of one displacement unit, the volume 408 is connected to the working spaces of the other displacement unit. In this case, the first displacement unit can be used as a heat engine to generate a pressure change and thus an oscillation of the liquid ring 403 by supplying its working spaces with liquid quantities at different temperatures. The other displacement unit can generate heat and cold in its working spaces and thus in the liquid quantities discharged from them by the resulting change in the volume 408 and the corresponding change in pressure. This structure corresponds to a duplex Stirling machine.

1. A device for converting thermal, mechanical and/or electrical energy quantities into other thermal, electrical and/or mechanical energy quantities, the device comprising:
at least one volume comprising a liquid quantity; and
at least one partial volume with a working medium,
wherein the at least one partial volume is limited by volume delimiting elements and a liquid surface, and wherein at least one of the volume delimiting elements or the liquid quantity is configured to change its position relative to other volume delimiting elements or the liquid quantity in such a way as to change a size of the at least one partial volume,
wherein the at least one partial volume and the liquid quantity perform a rotational movement about an axis of rotation, so that centrifugal forces act on the liquid quantity, and
wherein heat quantities are suppliable to or removable from the liquid quantity in that at least one of:
a) a part of the liquid quantity is flowable into and out of the at least one volume from outside the device through openings, or
b) the liquid quantity is thermally coupled to another liquid quantity by one or more heat exchangers.

2. The device according to claim 1, wherein heat exchanger elements are located in the at least one partial volume, wherein the heat exchanger elements periodically dip in and out of the liquid quantity during movement of a volume change element.

3. The device according to claim 1, wherein the at least one partial volume comprises at least two partial volume that are connected to one another via a gas-permeable connection in such a way that a pressure equalization between the at least two partial volumes is to take place by the gas-permeable connection.

4. The device according to claim 1, wherein the at least one partial volume comprises a first partial volume that is a compression working space in which the working medium is predominantly compressed and a second partial volume that is an expansion working space in which the working medium is predominantly expanded.

5. The device according to claim 1, wherein at least one volume change element or a volume delimiting element is designed as a hollow flask, an interior of which is bounded by the hollow flask itself and by a liquid quantity except for openings for gas-permeable connections to other partial volumes.

6. The device according to claim 1, wherein the size of at the least one partial volume changes in such a way that a second derivative of a course of the at least one volume over time has at least two local maxima or at least two local minima per period.

7. The device according to claim 1, wherein the working medium additionally flows through a heat exchanger or a regenerator during flow from a first partial volume of the at least one partial volume into another partial volume of the at least one partial volume.

8. The device according to claim 1, further comprising:
a volume change element configured to perform a rotational movement about an axis of rotation which is different from the axis of rotation of the liquid quantity or other volume delimiting elements.

9. The device according to claim 1, wherein an additional pressure change element causes a periodic change of pressure in the at least one partial volume, wherein the additional pressure change element is completely gas-tight except for a connection to the at least one partial volume and is designed as a diaphragm compressor.

10. The device according to claim 1, wherein at least one of gaps, elements or sealing elements movable relative to each other are additionally sealed by liquid quantities on which a centrifugal force acts.

11. The device according to claim 9, wherein the additional pressure change element comprises an additional element being mounted displaceably in a rotor configured to rotate eccentrically with respect to a housing, wherein the additional element is configured to periodically change its position in the rotor due to the centrifugal forces of the rotation and thus to periodically change a volume limited by the rotor, by the additional element and by at least one liquid quantity.

12. The device according to claim 1, wherein displaceably mounted volume delimiting elements limit partial volumes filled with working medium and thereby do not perform a movement in liquid quantities relative to the liquid quantities which have a movement component perpendicular to their movement relative to the volume delimiting elements in which they are displaceably mounted.

13. The device according to claim 1, further comprising at least two volumes, wherein the at least two volumes are limited by the volume delimiting elements in such a way that the volume delimiting elements prevent a flow out of liquid out of the volumes or a flow of liquid between the volumes except for the liquid quantity intended for supply and discharge heat quantities from/to outside the device.

14. A thermoelectric, thermomechanical or thermal converter for converting thermal, mechanical and/or electrical energy quantities into other thermal, electrical and/or mechanical energy quantities, comprising:
at least one device comprising:
at least one volume comprising a liquid quantity; and
at least one partial volume with a working medium,
wherein the at least one partial volume is limited by volume delimiting elements and a liquid surface, and wherein at least one of the volume delimiting elements or the liquid quantity is configured to change its position relative to other volume delimiting elements or the liquid quantity in such a way as to change a size of the partial volume,
wherein the partial volume and the liquid quantity perform a rotational movement about an axis of rotation, so that centrifugal forces act on the liquid quantity, and
wherein heat quantities are suppliable to or removable from the liquid quantity in that at least one of:
a) a part of the liquid quantity is flowable into and out of the at least one volume from outside the device through openings, or
b) the at least one liquid quantity is thermally coupled to another liquid quantity by one or more heat exchangers,
wherein a Stirling process, an Ericsson process, a Vuilleumier process, a Clausius-Rankine process, a Joule process or a mixed form of such processes is realized thereby.

15. (canceled)

16. The device of claim 2, wherein the heat exchanger elements comprise at least one of rods, grids, nets or relatively planar elements, and wherein planes of the relatively planar elements are aligned parallel to a direction of movement of the heat exchanger elements relative to the liquid quantity into which the heat exchanger elements periodically dip in and out.

17. The device according to claim 1, wherein all gaps or seals which are located between volume change elements and other volume delimiting elements only limit volumes from each other which have the same pressures except for effects of flow resistances.

18. The device according to claim 1, wherein at least two partial volumes of the at least one partial volume form a total volume which is completely sealed gas-tight to an outside except for a connection to an additional pressure change element.

19. The device according to claim 1, wherein the device contains at least three partial volumes which are connected to one another in a gas-permeable manner.

20. The device according to claim 8, wherein a position of the axis of rotation of the volume change element is configured to perform a circular movement or another movement relative to the axis of rotation of the liquid quantities or other volume delimiting elements.

21. The device according to claim 1, wherein an additional pressure change element causes a periodic change of pressure in the at least one partial volume, wherein the additional pressure change element is formed by a liquid quantity which performs a periodic displacement oscillation.
